(19) United States
(12) Patent Application Publication
(10) Pub. No.: US 2017/0164051 A1
(43) Pub. Date: Jun. 8, 2017

(54) VIDEO AUTO-PLAY IMPLEMENTATION AND ELECTRONIC EQUIPMENT

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Qingqing Han, Beijing (CN)

(21) Appl. No.: 15/240,612

(22) Filed: Aug. 18, 2016

Related U.S. Application Data
(63) Continuation of application No. PCT/CN2016/088473, filed on Jul. 4, 2016.

(30) Foreign Application Priority Data
Dec. 3, 2015 (CN) 201510881620.5

(51) Int. Cl. H04N 21/443; H04W 52/02; H04N 21/414; H04N 21/422; G11B 27/34; H04N 21/472; H04W 4/02; G11B 27/00

(52) U.S. Cl. CPC H04N 21/4436; H04W 4/027; H04W 52/0264; H04W 4/028; G11B 27/005; H04N 21/42222; G11B 27/34; H04N 21/47217; H04N 21/41407

(57) ABSTRACT

The present disclosure is directed to a method and electronic device for implementing video auto-play. The method includes: monitoring an acceleration of a motion of a terminal device in playing of a video file; comparing the acceleration with a preset threshold, and when a comparison result is a predetermined result, determining a playing state of the video file; when the playing state of the video file is Play, ceasing the playing of the video file; when the playing state of the video file is Pause, restarting the playing of the video file.

### CROSS REFERENCE TO RELATED APPLICATION

This application is a continuation of International PCT Patent Application No. PCT/CN2016/088473, filed Jul. 4, 2016 (attached hereto as an Appendix), and claims benefit/priority of Chinese patent application entitled “A VIDEO AUTO-PLAY IMPLEMENTATION AND ELECTRONIC EQUIPMENT”, application number 201510881620.5, filed with the State Intellectual Property Office of China on Dec. 3, 2015, which are all incorporated herein by reference in entirety.

### TECHNICAL FIELD

The disclosure relates to the field of media communication, and in particular, to a method and electronic device for implementing video auto-play.

### BACKGROUND

With rapid development of technologies of computer communication, internet, and multimedia, the application of video watching is increasingly widespread. Now, a user may watch a video at any time or anywhere, regardless of indoor or outside.

In the prior art, during watching a video, when a user wants to perform a play operation or cease operation of a player, the user needs to manually operate a specific button to achieve the above operation. Particularly, in a specific occasion, for example, a densely populated place such as public transport vehicle, the video watching and the playing operation or pause operation may be difficult or inconvenient, which may degrade the quality of user's experience.

### SUMMARY

Based on above, one object of the disclosure may provide a method and electronic device for implementing video auto-play, so as to solve a problem that in media playing, the play and pause of a video file is achieved only by manually operate a specific button in a player.

Based on the above object, according to a first aspect of the disclosure, there is provided the method for implementing video auto-play, which includes:

at an electronic device:

monitoring an acceleration of a motion of a terminal device in playing of a video file;

comparing the acceleration with a preset threshold, and if a comparison result is a predetermined result, determining a playing state of the video file;

when the playing state of the video file is Play, ceasing the playing of the video file, or when the playing state of the video file is Pause, restarting the playing of the video file.

According to another aspect of the disclosure, there is further provided a computer storage medium on which a program is stored, wherein when executed, the program may implement a part or all of the steps in each implementation of the method for implementing video auto-play according to the disclosure.

In another aspect, the disclosure may further provide an electronic device for implementing video auto-play, which includes:

a processor;

a memory configured to store instructions executable by the processor,

wherein the processor is configured to:

monitor an acceleration of a motion of a terminal device in playing of a video file;

compare the acceleration with a preset threshold, and determine a playing state of the video file when a comparison result is a predetermined result; and

cease the playing of the video file when the playing state of the video file is Play, and restart the playing of the video file when the playing state of the video file is Pause.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart of a method for implementing video auto-play according to an embodiment of the disclosure.

FIG. 2 is a schematic flowchart of a method for implementing video auto-play according to an embodiment of the disclosure.

FIG. 3 is a structure schematic diagram of an apparatus for implementing video auto-play according to the disclosure.

FIG. 4 is a schematic structure diagram of hardware of an electronic device for implementing video auto-play according to the disclosure.

### DETAILED DESCRIPTION

In order to make the objects, technical solutions and advantages of embodiments of the disclosure more clear, the disclosure will be further described in detail below in conjunction with the specific embodiments with reference to the drawings.

According to the present situation of the use of a multimedia platform, when a user is watching a video file, if the user wants to cease the video file, he/she must manually click a pause button in a playing page of the video file; and if the user wants to restart the video file ceased, the user has to manually click a play button in the playing page of the video file. The ceasing of the video file or the playing of the video file is not convenient, thus causing a very bad experience of user. Therefore, in order to solve the above problem, the disclosure may provide a technical solution, from the view of the user, to automatically play and cease the video file on a multimedia platform.

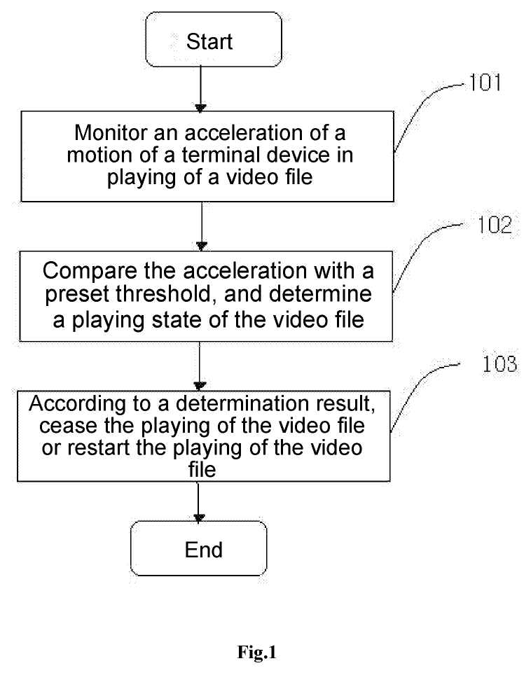

FIG. 1 is a schematic flowchart of a method for implementing video auto-play according to a first embodiment of the present disclosure. The method includes the following steps.

In step 101, an acceleration of a motion of a terminal device is monitored in playing of a video file.

In the embodiment, during playing the video file in a page of video playing on the terminal device, the motion of the terminal device is monitored. Preferably, the acceleration of the motion of the terminal device is monitored during the use of the terminal device. Preferably, the acceleration of the motion of the terminal device is monitored with a gyroscope or gravity sensor.

In step 102, the acceleration is compared with a preset threshold, and when a comparison result is a predetermined result, a playing state of the video file is determined.

In the embodiment, during monitoring the acceleration of the terminal device, when it is monitored that the acceleration of the motion of the terminal device exceeds the preset threshold, it is required to determine a current playing state of the video file in the page of video playing, wherein the playing state may include Play or Pause. Thus, in the present embodiment, it may be monitored that the acceleration of the motion of the terminal device exceeds the preset threshold, and the playing state of the video file may be determined, so as to make preparations to automatically change the playing state of the video file on the terminal device in step 103.

Preferably, in step 102, when it is monitored that the acceleration of the motion of the terminal device exceeds the preset threshold, it is firstly determined whether a direction of the motion of the terminal device is a preset motion direction to leave the page of video playing, before the current playing state of the video file in the page of video playing is determined. In other words, an exceeded threshold for the acceleration and the direction to leave the page of video playing are preset. Further, the monitoring of the acceleration and the motion direction may be performed with a gyroscope or gravity sensor.

Further, according to a determination result on whether the direction of the motion of the terminal device is the preset motion direction to leave the page of video playing, if the direction is the preset motion direction, a current progress of the playing of the video file is stored and the page of video playing is leaved. In other words, the current progress of play is stored and the page of video playing is leaved regardless of whether the current playing state of the video file is Play or Pause. If the direction is not the preset motion direction, a current playing state of the video file in the page of video playing is determined; and if the current playing state of the video file in the page of video playing is Play, the playing of the video file is ceased, or if the current playing state of the video file in the page of video playing is Pause, the playing of the video file is restarted. Thus, in the present embodiment, by adding the preset direction to leave the page of video playing of the terminal device, the page of video playing may be closed automatically and quickly.

In a preferred embodiment, in step 102, when it is monitored that the acceleration of the motion of the terminal device exceeds the preset threshold, before a current playing state of the video file in the page of video playing is determined or it is determined whether the direction of the motion of the terminal device is the preset motion direction to leave the page of video playing, it is firstly determined whether the acceleration has reached a preset acceleration maximum threshold. Then, according to a determination result, if the acceleration has reached a preset acceleration maximum threshold, a current progress of the playing of the video file is stored and the terminal device is set to a screen off state. In other words, when the acceleration of the motion of the terminal device is so large and reaches the preset acceleration maximum threshold, no matter whether the current playing state of the video file is Play or Pause, the current progress of the playing of the video file is stored and the terminal device is directly set to the screen off state.

Moreover, if the acceleration has not reached the acceleration maximum threshold, then the current playing state of the video file in the page of video playing is determined, or before the current playing state of the video file in the page of video playing is determined, it is determined whether the direction of the motion of the terminal device is the preset motion direction to leave the page of video playing. Thus, in the present embodiment, only by monitoring the acceleration of the motion of the terminal device, the terminal device is set to the screen off state automatically. Therefore, this achieves the storage of the progress of video playing and closes the screen of the terminal device.

In step 103, according to a determination result, the playing of the video file is ceased or restarted. Wherein, if the current playing state of the video file in the page of video playing is Play, the playing of the video file is ceased; or if the current playing state of the video file in the page of video playing is Pause, the playing of the video file is restarted.

In another embodiment, after the playing of the video file is ceased when the current playing state of the video file in the page of video playing is Play, a screen protection program may be started. Thus, content of the video file ceased may be covered by the screen protection program, and preferably, the screen protection program may be configured as a way that content of the screen can be covered. Therefore, it may be guaranteed that the content of the video file is not seen by other people, thus a high security is guaranteed and the power of the terminal device may be also saved.

Further, it is determined whether an operation for the terminal device exists during the screen protection. If the operation for the terminal device exists, the screen protection program may be shut down, and it is determined whether the acceleration of the motion of the terminal device exceeds the preset threshold in the operation; if yes, the playing of the video file may be restarted, or if not, the page of video playing may be leaved. If the operation for the terminal device does not exist, the screen protection program may continue to be run. Thus, the terminal device in which the screen protection program is started may still restart the playing of the video file or directly leave the page of video playing, and of course, the screen protection program may continue to be run.

Preferably, after the screen protection program is started, the power of the terminal device may be monitored in a process that the terminal device is in a protection state. When it is monitored that the power of the terminal device is lower than a preset power threshold, the screen protection program is shut down, and the current progress of the playing of the video file is stored and the page of video playing is leaved. Thus, in the present embodiment, the utilization for the power of the terminal device may be maximized, and the use-life of the terminal device may be lengthened.

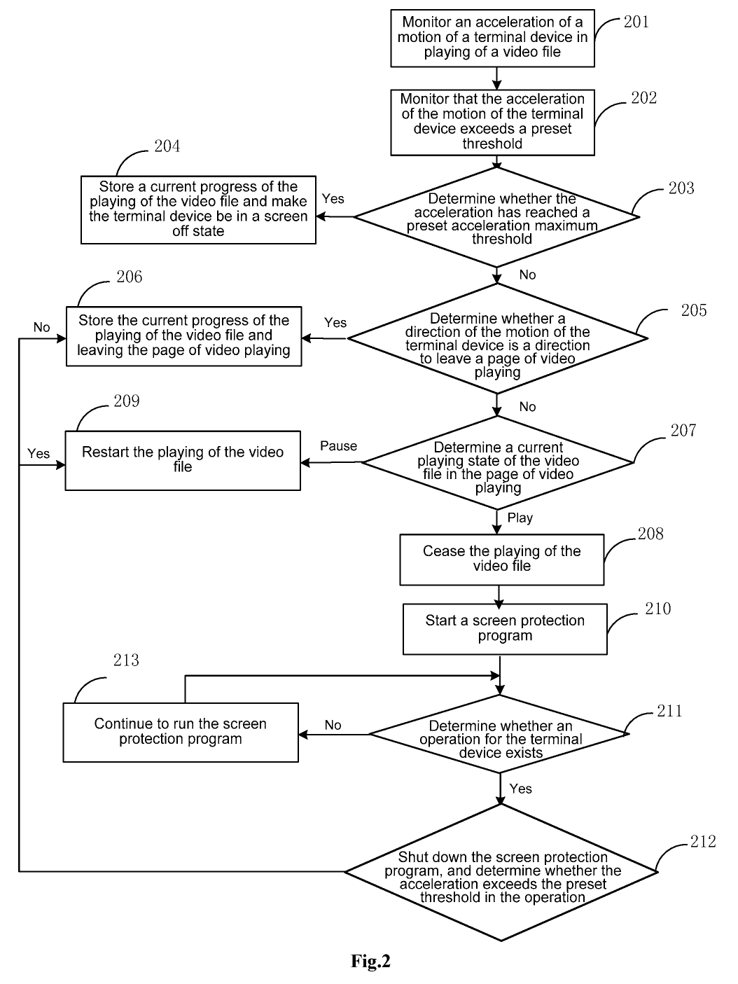

As an exemplary embodiment of the present disclosure, referring to FIG. 2, the method for implementing video auto-play may comprise the following steps.

In step 201, an acceleration of a motion of a terminal device is monitored in playing of a video file.

In step 202, it is monitored that the acceleration of the motion of the terminal device exceeds a preset threshold.

In step 203, it is determined whether the acceleration has reached a preset acceleration maximum threshold; and if yes, step 204 is executed, or if not, step 205 is executed.

In step 204, the current progress of the playing of the video file is stored and the terminal device is set to a screen off state.

In step 205, it is determined whether a direction of the motion of the terminal device is a preset direction to leave the page of video playing; and if yes, step 206 is executed, or if not, step 207 is executed.

In step 206, the current progress of the playing of the video file is stored and the page of video playing is leaved.

In step 207, a current playing state of the video file in the page of video playing is determined; and if the playing state is Play, step 208 is executed, or if the playing state is Pause, step 209 is executed.

In step 208, the playing of the video file is ceased and step 210 is executed.

In step 209, the playing of the video file is restarted.

In step 210, the screen protection program is started.

In step 211, it is determined whether an operation for the terminal device exists during performing the screen protection program; and if the operation exists, step 212 is executed, or if the operation does not exist, step 213 is executed.

In step 212, the screen protection program may be shut down, and it is determined whether the acceleration of the motion of the terminal device exceeds the preset threshold in the operation; and if yes, step 209 is executed, or if not, step 206 is executed.

In step 213, the screen protection program may continue to be run, and the method returns to step 211.

In another referable embodiment, after step 210 is executed, the power of the terminal device may be further monitored. When it is monitored that the power of the terminal device is lower than a preset power threshold, the screen protection program is shut down, the current progress of the playing of the video file is stored and the page of video playing is leaved.

In another aspect of an embodiment of the present disclosure, there is provided an apparatus for implementing video auto-play. As illustrated in FIG. 3, the apparatus for implementing video auto-play includes a video playing monitoring unit 301, a video playing determining unit 302, and a playing state changing unit 303, which are sequentially connected. The video playing monitoring unit 301 is configured to monitor an acceleration of a motion of a terminal device in playing of a video file. Preferably, the acceleration of the motion of the terminal device may be monitored with a gyroscope or a gravity sensor. The video playing determining unit 302 is configured to compare the acceleration with a preset threshold, and when a comparison result is a predetermined result, a playing state of the video file is determined. The playing state changing unit 303 is configured to cease or restart the playing of the video file according to a determination result. Preferably, according to the determination result, the playing state changing unit 303 ceases the playing of the video file if the playing state of the video file in the page of video playing is currently Play, or restart the playing of the video file if the playing state of the video file in the page of video playing is currently Pause.

In another embodiment of the present disclosure, when monitoring that the acceleration of the motion of the terminal device exceeds the preset threshold, the video playing determining unit 302 first determines whether the direction of the motion of the terminal device is a preset motion direction to leave the page of video playing before determining a current playing state of the video file in the page of video playing. In other words, an exceeded threshold for the acceleration is set, and the direction to leave the page of video playing is also set. Preferably, the acceleration and the motion direction may be monitored with a gyroscope or a gravity sensor.

Further, according to a determination result on whether the direction of the motion of the terminal device is the preset motion direction to leave the page of video playing; if the direction of the motion of the terminal device is the preset motion direction to leave the page of video playing, the current progress of the playing of the video file is stored and the page of video playing is leaved. In other words, no matter whether the current playing state of the video file is Play or Pause, the playing progress is stored and the page of video playing is leaved. If the direction of the motion of the terminal device is not the preset motion direction to leave the page of video playing, a current playing state of the video file in the page of video playing is determined; and if the current playing state of the video file in the page of video playing is Play, the playing of the video file is ceased, or if the current playing state of the video file in the page of video playing is Pause, the playing of the video file is restarted.

Preferably, when monitoring that the acceleration of the motion of the terminal device exceeds the preset threshold, the video playing determining unit 302 first determines whether the acceleration has reached a preset acceleration maximum threshold before determining the current playing state of the video file in the page of video playing or determining whether the direction of the motion of the terminal device is the preset motion direction to leave the page of video playing. Then, according to a determination result, if the acceleration has reached the preset acceleration maximum threshold, the video playing determining unit 302 stores the current progress of the playing of the video file and sets the terminal device to a screen off state. In other words, when the acceleration of the motion of the terminal device is quick and reaches the preset acceleration maximum threshold, no matter whether the current playing state of the video file is Play or Pause, the current progress of the playing of the video file is stored and the terminal device is directly set to the screen off state.

Moreover, if the acceleration has not reached the acceleration maximum threshold, a current playing state of the video file in the page of video playing is determined, or it is determined whether the direction of the motion of the terminal device is the preset motion direction to leave the page of video playing before the current playing state of the video file in the page of video playing is determined.

In a referable embodiment, the playing state changing unit 303 starts a screen protection program after ceasing the playing of the video file, when the current playing state of the video file in the page of video playing is Play. Therefore, it may be guaranteed that the content of the video file is not seen by other people, thus a high security is guaranteed and the power of the terminal device may be also saved. During the screen protection, it is determined whether an operation for the terminal device exists. If the operation for the terminal device exists, the screen protection program is shut down, and it is determined whether the acceleration of the motion of the terminal device exceeds a preset threshold in the operation. If the acceleration of the motion of the terminal device exceeds the preset threshold, the playing of the video file is restarted, or if the acceleration of the motion of the terminal device does not exceed the preset threshold, the page of video playing is leaved. If the operation for the terminal device does not exist, the screen protection program may continue to be run.

Preferably, after the screen protection program is started, the power of the terminal device is monitored in a process that the terminal device is in a screen protection state. When it is monitored that the power of the terminal device is lower than a preset power threshold, the screen protection program is shut down, the current progress of the playing of the video file is stored, and the page of video playing is leaved. Thus, in the present embodiment, the utilization of the power of the terminal device may be maximized, and the use-life of the terminal device may be lengthened.

It should be noted that, the specific implementation of the apparatus for implementing video auto-play according to an embodiment of the present disclosure is omitted here since it has been described in the method for implementing video auto-play as above described.

In summary, the method and electronic device for implementing video auto-play according to the present disclosure creatively solves a problem that the play and pause of a video file through manual operation is inconvenient, achieves an automatic way of video play and pause, and makes the video service more customized and customer-oriented. Furthermore, the whole method and electronic device for implementing video auto-play are compact and are easy to implement.

According to an embodiment of the present disclosure, there is provided a non-volatile computer storage medium, which is stored with computer executable instructions, and the computer executable instructions are configured for performing the method for implementing video auto-play in any embodiments.

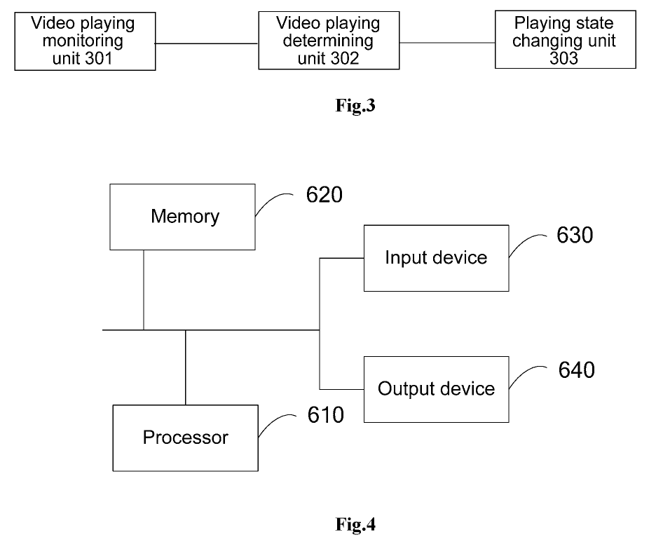

FIG. 4 is a schematic diagram of hardware structure of an electronic device used to perform the method for implementing video auto-play according to an embodiment of the present disclosure, as shown in FIG. 4, the device includes:

One or more processors 610 and a memory 620, FIG. 4 illustrates one processor 610 as an example.

The device for the method for implementing video auto-play may further include an input device 630 and an output device 640.

The processor 610, the memory 620, the input device 630 and the output device 640 may be connected with each other through bus or other forms of connections. FIG. 4 illustrates bus connection as an example.

As a non-volatile computer-readable storage medium, the memory 620 may be configured to store non-volatile software program, non-volatile computer executable program and modules, such as program instructions/modules corresponding to the method for implementing video auto-play according to the embodiments of the disclosure (for example, the video playing monitoring unit 301, the video playing determining unit 302, and the playing state changing unit 303 as illustrated in FIG. 3). By executing the non-volatile software program, instructions and modules stored in the memory 620, the processor 610 may perform various functional applications of the server and data processing, that is, the method for implementing video auto-play according to the above mentioned embodiments.

The memory 620 may include a program storage area and a data storage area, wherein, the program storage area may be stored with the operating system and applications which are needed by at least one functions, and the data storage area may be stored with data which is created according to use of the device for implementing video auto-play. Further, the memory 620 may include a high-speed random access memory, and may further include non-volatile memory, such as at least one of disk memory device, flash memory device or other types of non-volatile solid state memory device. In some embodiments, optionally, the memory 620 may include memory provided remotely from the processor 610, and such remote memory may be connected with the device for implementing video auto-play through network connections, the examples of the network connections may include but not limited to internet, intranet, LAN (Local Area Network), mobile communication network or combinations thereof.

The input device 630 may receive inputted number or character information, and generate key signal input related to the user settings and functional control of the device for implementing video auto-play. The output device 640 may include a display device such as a display screen.

The above one or more modules may be stored in the memory 620, when these modules are executed by the one or more processors 610, the method for implementing video auto-play according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smarttoys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for implementing video auto-play, comprising:
at an electronic device:
monitoring an acceleration of a motion of a terminal device in playing of a video file;
comparing the acceleration with a preset threshold, and when a comparison result is a predetermined result, determining a playing state of the video file; and
ceasing the playing of the video file when the playing state of the video file is Play; and restarting the playing of the video file when the playing state of the video file is Pause.

2. The method according to claim 1, wherein after the ceasing the playing of the video file, the method further comprises:
starting a screen protection program and determining whether an operation for the terminal device exists;
when the operation for the terminal device exists, shutting down the screen protection program and determining whether the acceleration of the motion of the terminal device exceeds the preset threshold in the operation; and if the acceleration exceeds the preset threshold, restarting the playing of the video file, or if the acceleration does not exceed the preset threshold, leaving a page of video playing; and
when the operation for the terminal device does not exist, continuing to run the screen protection program.

3. The method according to claim 2, wherein after the starting the screen protection program, the method further comprises:
monitoring power of the terminal device; and
when it is monitored that the power of the terminal device is lower than a preset power threshold, shutting down the screen protection program, storing a current progress of the playing of the video file and leaving the page of video playing.

4. The method according to claim 1, wherein when it is monitored that the acceleration of the motion of the terminal device exceeds the preset threshold, determining whether a direction of the motion of the terminal device is a preset direction;
if the direction of the motion of the terminal device is the preset direction, storing a current progress of the playing of the video file and leaving a page of video playing; or if the direction of the motion of the terminal device is not the preset direction, determining a current playing state of the video file in the page of video playing, and according to a determination result, if the current playing state of the video file in the page of video playing is Play, ceasing the playing of the video file, or if the current playing state of the video file in the page of video playing is Pause, restarting the playing of the video file.

5. The method according to claim 1, wherein when it is monitored that the acceleration of the motion of the terminal device exceeds the preset threshold, determining whether the acceleration has reached a preset acceleration maximum threshold;
according to a determination result, if the acceleration has reached the preset acceleration maximum threshold, storing a current progress of the playing of the video file and making the terminal device be in a screen off state; if the acceleration has not reached the preset acceleration maximum threshold, determining a current playing state of the video file in the page of video playing, and according to a determination result, if the current playing state of the video file in the page of video playing is Play, ceasing the playing of the video file, or if the current playing state of the video file in the page of video playing is Pause, restarting the playing of the video file.

6. An electronic device, comprising:
at least one processor; and
a memory communicably connected with the at least one processor,
wherein the memory is stored with instructions executable by the at least one processor, and the instructions are executed by the at least one processor to cause the at least one processor to:
monitor an acceleration of a motion of a terminal device in playing of a video file;
compare the acceleration with a preset threshold, and when a comparison result is a predetermined result, determine a playing state of the video file; and
cease the playing of the video file when the playing state of the video file is Play; and restart the playing of the video file when the playing state of the video file is Pause.

7. The electronic device according to claim 6, wherein the at least one processor is further caused to:
start a screen protection program and determine whether an operation for the terminal device exists;
when the operation for the terminal device exists, shut down the screen protection program and determine whether the acceleration of the motion of the terminal device exceeds the preset threshold in the operation; and if the acceleration exceeds the preset threshold, restart the playing of the video file, or if the acceleration does not exceed the preset threshold, leave a page of video playing; and
when the operation for the terminal device does not exist, continue to run the screen protection program.

8. The electronic device according to claim 7, wherein the at least one processor is further caused to:
monitor power of the terminal device; and
when it is monitored that the power of the terminal device is lower than a preset power threshold, shut down the screen protection program, store a current progress of the playing of the video file and leave the page of video playing.

9. The electronic device according to claim 6, wherein the at least one processor is further caused to:
when it is monitored that the acceleration of the motion of the terminal device exceeds the preset threshold, determine whether a direction of the motion of the terminal device is a preset direction;
if the direction of the motion of the terminal device is the preset direction, store a current progress of the playing of the video file and leave a page of video playing; or if the direction of the motion of the terminal device is not the preset direction, determine a current playing state of the video file in the page of video playing, and according to a determination result, if the current playing state of the video file in the page of video playing is Play, cease the playing of the video file, or if the current playing state of the video file in the page of video playing is Pause, restart the playing of the video file.

10. The electronic device according to claim 6, wherein the at least one processor is further caused to:
when it is monitored that the acceleration of the motion of the terminal device exceeds the preset threshold, determine whether the acceleration has reached a preset acceleration maximum threshold;
according to a determination result, if the acceleration has reached the preset acceleration maximum threshold, store a current progress of the playing of the video file and make the terminal device be in a screen off state; if the acceleration has not reached the preset acceleration maximum threshold, determine a current playing state of the video file in the page of video playing, and according to a determination result, if the current playing state of the video file in the page of video playing is Play, cease the playing of the video file, or if the current playing state of the video file in the page of video playing is Pause, restart the playing of the video file.

11. A non-transitory computer-readable storage medium storing executable instructions, wherein the executable instructions is performed by an electronic device to cause the electronic device to:
monitor an acceleration of a motion of a terminal device in playing of a video file;
compare the acceleration with a preset threshold, and when a comparison result is a predetermined result, determine a playing state of the video file; and
cease the playing of the video file when the playing state of the video file is Play; and restart the playing of the video file when the playing state of the video file is Pause.

12. The non-transitory computer-readable storage medium according to claim 11, wherein the electronic device is further caused to:
start a screen protection program and determine whether an operation for the terminal device exists;
when the operation for the terminal device exists, shut down the screen protection program and determine whether the acceleration of the motion of the terminal device exceeds the preset threshold in the operation; and if the acceleration exceeds the preset threshold, restart the playing of the video file, or if the acceleration does not exceed the preset threshold, leave a page of video playing; and
when the operation for the terminal device does not exist, continue to run the screen protection program.

13. The non-transitory computer-readable storage medium according to claim 12, wherein the electronic device is further caused to:
monitor power of the terminal device; and
when it is monitored that the power of the terminal device is lower than a preset power threshold, shut down the screen protection program, store a current progress of the playing of the video file and leave the page of video playing.

14. The non-transitory computer-readable storage medium according to claim 11, wherein the electronic device is further caused to:
when it is monitored that the acceleration of the motion of the terminal device exceeds the preset threshold, determine whether a direction of the motion of the terminal device is a preset direction;
if the direction of the motion of the terminal device is the preset direction, store a current progress of the playing of the video file and leave a page of video playing; or if the direction of the motion of the terminal device is not the preset direction, determine a current playing state of the video file in the page of video playing, and according to a determination result, if the current playing state of the video file in the page of video playing is Play, cease the playing of the video file, or if the current playing state of the video file in the page of video playing is Pause, restart the playing of the video file.

15. The non-transitory computer-readable storage medium according to claim 11, wherein the electronic device is further caused to:
when it is monitored that the acceleration of the motion of the terminal device exceeds the preset threshold, determine whether the acceleration has reached a preset acceleration maximum threshold;
according to a determination result, if the acceleration has reached the preset acceleration maximum threshold, store a current progress of the playing of the video file and make the terminal device be in a screen off state; if the acceleration has not reached the preset acceleration maximum threshold, determine a current playing state of the video file in the page of video playing, and according to a determination result, if the current playing state of the video file in the page of video playing is Play, cease the playing of the video file, or if the current playing state of the video file in the page of video playing is Pause, restart the playing of the video file.
